(19) United States
(12) Patent Application Publication
(10) Pub. No.: US 2024/0430943 A1
(43) Pub. Date: Dec. 26, 2024

(54) ENHANCING RANDOM ACCESS REPORT WITH INDICATION OF RANDOM ACCESS PERFORMED TOWARD MN OR SN

(71) Applicant: Telefonaktiebolaget LM Ericsson (publ), Stockholm (SE)

(72) Inventors: Ali PARICHEHREHTEROUJENI, Linköping (SE); Angelo CENTONZA, Granada (ES); Pradeepa RAMACHANDRA, Linköping (SE); Marco BELLESCHI, Solna (SE); Tahmineh TORABIAN ESFAHANI, Sollentuna (SE)

(21) Appl. No.: 18/699,279

(22) PCT Filed: Sep. 19, 2022
(86) PCT No.: PCT/SE2022/050821

§ 371 Date: Apr. 6, 2024

Related U.S. Application Data
(60) Provisional application No. 63/252,840, filed on Oct. 6, 2021.

(51) Int. Cl. H04W 74/0833; H04W 24/10

(52) U.S. Cl. CPC H04W 74/0833; H04W 24/10

(57) ABSTRACT

A method performed by a user equipment (UE) includes performing a random access (RA) procedure towards a cell of a radio access network, logging a first indication that indicates whether the cell towards which the RA procedure was performed belongs to a master cell group, MEG, (MCG) or a secondary cell group, (SCG) serving the UE, and generating an RA report that includes the first indication. A method performed by a radio access network, (RAN) node, includes receiving an RA preamble from a UE as part of the RA procedure towards a cell served by the RAN node, and receiving the RA report associated with the RA procedure indicating whether the cell towards which the RA procedure was performed belongs to the MCG or the SCG serving the UE.

### TECHNICAL FIELD

The present disclosure relates generally to communications, and more particularly to communication methods and related devices and nodes supporting wireless communications.

### BACKGROUND

In LTE, the report of random access channel (RACH) information when a random access (RA) procedure is performed may be requested by the network via the UE Information procedure, in the case where a RACH procedure was successful.

For each RACH procedure, a user equipment (UE) stores the number of preambles sent, which corresponds to the parameter PREAMBLE_TRANSMISSION_COUNTER in the medium access control (MAC) specification, e.g. Ref. [1]. In the RA procedure in Long Term Evolution (LTE), the UE sends a preamble and waits for a random-access response (RAR) during a pre-configured time window (RAR window). If the RAR does not come within that time, the UE adjusts some preamble transmission parameters (e.g., transmission power) and transmits the preamble again (in what is called power ramping adjustment). If the procedure is successful, then the network will respond to the preamble. The RACH report includes an indication of how many times the UE needed to ramp the power before the procedure was successful.

The random-access procedure, and specifically the meaning of the PREAMBLE_TRANSMISSION_COUNTER is described in the MAC specifications. During the initialization the counter is set to 1. Then, at the first attempt, the UE shall set the preamble received target power, i.e., the expected power in the RACH receiver at the eNB, to the initial transmission power (parameter provided by the eNB, e.g., via SIB2 in LTE). These values may range from −120 dBm to −90 dBm, and are provided as part of the power ramping parameters. Note that this may also be a parameter to be adjusted later (a value that is too large may lead to a high RACH success rate, but it could also create unnecessary uplink interference, which may be problematic, especially in high load scenarios).

The PREAMBLE_RECEIVED_TARGET_POWER parameter will be in this first attempt the preambleInitialReceivedTargetPower+DELTA_PREAMBLE (offset depending on the preamble format that has been configured by the network in prach-ConfigIndex, ranging from −3 dB to 8 dB).

Then, if no response is received within the configured RAR time window, another parameter, PREAMBLE_TRANSMISSION_COUNTER, is incremented by 1. Then, it is checked if the number of increments has reached its maximum value or not (which is also a configurable parameter that can be adjusted).

Assuming the UE may still perform preamble re-transmission, power ramping occurs, and the new preamble transmission power is incremented by a power ramping step, which is also a configurable parameter. The transmission power in this second attempt will then be:

$$PREAMBLE\_RECEIVED \_TARGET \_POWER = preambleInitialReceivedTargetPower + DELTA\_PREAMBLE + 1 * powerRampingStep$$

The parameter powerRampingStep may be 0 dB, 2 dB, 4 dB or 6 dB.

Power ramping parameters as broadcasted in SIB2 are shown in Table 1 below.

TABLE 1
Power Ramping Parameters

| | |
|---|---|
| PowerRampingParameters ::= | SEQUENCE { |
| powerRampingStep | ENUMERATED {dB0, dB2,dB4, dB6}, |
| preambleInitialReceivedTargetPower | ENUMERATED { |
| | dBm-120, dBm-118, dBm-116, dBm-114, dBm-112, |
| | dBm-110, dBm-108, dBm-106, dBm-104, dBm-102, |
| | dBm-100, dBm-98, dBm-96, dBm-94, |
| | dBm-92, dBm-90} |
| } | |

At the (N+1)-th attempt, the parameter

PREAMBLE_RECEIVED_TARGET_POWER is set as follows:
PREAMBLE_RECEIVED_TARGET_POWER=preambleInitialReceivedTargetPower+DELTA_PREAMBLE+N*powerRampingStep

That preamble power ramping procedure, in case of multiple preamble transmission attempts, is described in the MAC specifications, e.g., Ref. [1].

RACH configuration in New Radio (NR)

As in LTE, the RA procedure is described in the NR MAC specifications and parameters are configured by radio resource control (RRC) e.g. in system information or handover (RRCReconfiguration with reconfigurationWithSync). A random access attempt may be triggered in many different scenarios, for example, when the UE is in RRC_IDLE or RRC INACTIVE and want to access a cell that is camping on (i.e. transition to RRC CONNECTED).

In NR, RACH configuration is broadcast in the SIB1 system information blocko, as part of the servingCellConfigCommon information element (IE) (with both DL and UL configurations), where the RACH configuration is within the uplinkConfigCommon IE. The exact RACH parameters are within what is called initialUplinkBWP, since this is the part of the uplink (UL) frequency the UE shall access and search for RACH resources.

The RACH configuration focuses primarily on parameters related to the preamble power ramping functionality, i.e., power ramping step and initial power ramping, as shown for LTE in the previous section.

NR random access procedure (preamble power ramping)

In LTE, the RACH report to assist the network to perform RACH procedure adjustment contains the number of preamble transmissions until the procedure succeeds. It is also very clear what has happened at the UE between the first transmission and the last transmission until the procedure was considered successful, namely, that the UE applied power ramping with a configured step and transmitted the preamble once more.

As in LTE, a similar counter PREAMBLE_TRANSMISSION_COUNTER that assists the UE to perform power ramping, which is a RACH state variable, also exists in NR. And, as in LTE, during initialization, that counter is set to 1, so that the initial transmission power for the selected preamble is set as PREAMBLE_RECEIVED_TARGET_POWER=preambleReceivedTargetPower+DELTA_PREAMBLE. This is similar to LTE, where in the first attempt the transmission power is just the initial transmission power configured by the network plus a specified offset which depends on the selected preamble.

Also as in LTE, if no response is received within the configured RAR time window, PREAMBLE_TRANSMISSION_COUNTER is incremented by 1. Then, it is checked if the number of increments has reached its maximum value or not (also a configurable parameter that could be adjusted).

Differences in power ramping in NR and LTE

In NR, random access resource selection needs to be performed within a cell depending on measurements performed on synchronization signal blocks (SSBs) or channel state information reference signals (CSI-RSs). A cell in NR is basically defined by a set of these SSBs that may be transmitted in 1 (typical implementation for lower frequencies, e.g., below 6 GHz) or multiple downlink beams (typical implementation for lower frequencies, e.g., below 6 GHz). For the same cell, these SSBs carry the same physical cell identifier (PCI) and a master information block (MIB). For standalone operation, i.e., to support UEs camping on an NR cell, they also carry in SIB1 the RACH configuration, which comprises a mapping between the detected SSB covering the UE at a given point in time and the PRACH configuration (e.g., time, frequency, preamble, etc.) to be used. For that, each of these beams may transmit its own SSB which may be distinguished by an SSB index.

FIG. 1 shows an LTE cell with a single beam and an NR cell with multiple beams. The mapping between RACH resources and SSBs (or CSI-RS) is also provided as part of the RACH configuration (in RACH-ConfigCommon). Two parameters are relevant here, namely, #SSBs-per-PRACH-occasion: ⅛, ¼, ½, 1, 2, 8 or 16, which represents the number of SSBs per RACH occasion, and #CB-preambles-per-SSB preambles to each SS-block which indicates within a RACH occasion, how many preambles are allocated;

Referring to FIG. 2, in a first example, if the number of SSBs per RACH occasion is 1, and if the UE is under the coverage of a specific SSB e.g. SSB index 2, there will be a RACH occasion for that SSB index 2. If the UE moves and is now under the coverage of another specific SSB, e.g. SSB index 5, there will be another RACH occasion for that SSB index 5. That is, each SSB detected by a given UE would have its own RACH occasion. Hence, at the network side, upon detecting a preamble in a particular RACH occasion, the network knows exactly which SSB the UE has selected and, consequently, which downlink beam is covering the UE, so that the network can continue the downlink transmission e.g. RAR, etc. That factor 1 is an indication that each SSB has its own RACH resource. That is, a preamble detected there indicates to the network which SSB the UE has selected, and which downlink (DL) beam the network should use to communicate with the UE, such as the one to send the RAR.

Each SSB typically maps to multiple preambles (having different cyclic shifts and Zadoff-Chu roots) within a PRACH occasion, so that it is possible to multiplex different UEs in the same RACH occasions, as they may be under the coverage of the same SSB.

In a second example, shown in FIG. 3, the number of SSBs per RACH occasion is 2. Hence, a preamble received in that RACH occasion indicated to the network that one of the two beams are being selected by the UE. Thus, either the network has means via implementation to distinguish these two beams and/or should perform a beam sweeping in the downlink by transmitting the RAR in both beams, either simultaneously or, transmitting in one, waiting for a response from the UE, and if absent, transmit in the other.

Assuming now that in the first attempt the UE has selected an SSB (based on measurements performed in that cell), it has transmitted with initial power a selected preamble associated to the PRACH resource mapped to the selected SSB, and it has not received a RAR within the RAR time window. According to the specifications, the UE may still perform preamble re-transmission if the maximum number of allowed transmissions has not been reached.

As in LTE, at every preamble retransmission attempt, the UE may assume the same SSB as the previous attempt and perform power ramping similar to in LTE. A maximum number of attempts is also defined in NR, which is also controlled by the parameter PREAMBLE_TRANSMISSION_COUNTER.

On the other hand, different from LTE, at every preamble retransmission attempt, the UE may alternatively select a different SSB, as long as that new SSB has an acceptable quality (i.e., its measurements are above a configurable threshold). In that case, when a new SSB (or, in more general term, a new beam) is selected, the UE does not perform power ramping, but transmits the preamble with the same previously transmitted power. That is, the UE shall not re-initiate the power to the initial power transmission. That situation is shown in FIG. 4.

For that reason, a new variable is defined in the NR MAC specifications, e.g., Ref. [3], called PREAMBLE_POWER_RAMPING_COUNTER, in case the same beam is selected at a retransmission. At the same time, the previous LTE variable PREAMBLE_TRANSMISSION_COUNTER still exists, so that the total number of attempts is still limited, regardless of whether the UE performs SSB/beam re-selection or power ramping at each attempt.

Hence, if the initial preamble transmission, e.g. associated to SSB-2, does not succeed, and the UE selects the same SSB/beam, PREAMBLE_POWER_RAMPING_COUNTER is incremented (i.e. set to 2 in this second attempt) and the transmission power will be:

$$PREAMBLE\_RECEIVED \_TARGET \_POWER = preambleReceivedTargetPower + DELTA\_PREAMBLE + 1 * PREAMBLE\_POWER \_RAMPING \_STEP ;$$

Else, if instead the UE selects a different SSB/beam, the PREAMBLE_POWER_RAMPING_COUNTER is not incremented (i.e. remains 1) and the transmission power will be as in the first transmission:
PREAMBLE_RECEIVED_TARGET_POWER=preambleReceivedTargetPower+DELTA_PREAMBLE;

That preamble power ramping procedure, in case of multiple preamble transmission attempts, is described in the MAC specifications, e.g., Ref. [3].

### SUMMARY

Certain aspects of the disclosure and their embodiments may provide solutions to these or other challenges.

Some embodiments provide a method at a wireless terminal (also called User Equipment, or UE).

In particular, for a performed RA procedure, the UE logs a first indication that indicates whether a performed RA procedure is performed towards a cell belonging to the Master Cell Group (MCG), or toward a cell belonging the secondary Cell Group (SCG). The RA related information including the first indication will be logged in a list of RA reports, in such a way that each RA report includes an instance of the first indication.

The UE may send to a network node a second indication that indicates the availability of the logged RA information including the first indication indicating whether the RA procedure is performed towards a cell belonging to the MCG or belonging to the SCG.

In one embodiment the second indication indicates information concerning the standard release of the RA report. E.g., RA report from release 16 or release 17 according to the 3GPP specification. RAReportAvail-r16 or -r17 could include first indication.

In some embodiments, the second indication indicates, as a UE capability, that the UE supports the logging SCG RA procedure described above.

In some embodiments, the second indication indicates the radio access technology of the RA report. In a non-limiting example e.g., the RA belonging to the LTE network or to the NR network.

Currently, the NW can request a report without first receiving an availability indication.

The UE may receive a third indication from the network node that indicates a request to UE to send all or some of the RA reports, in the RA report list.

In one embodiment the third indication received from the network node indicates information concerning the release of the RA report. E.g., RA report from release 16 or release 17 according to the 3GPP specification.

In another embodiment, the third indication received from the network node indicates the radio access technology of the RA report. E.g., the RA belonging to the LTE network or to the NR network.

In another embodiment the third indication receive from the network node indicates whether the network wants the UE to report RA reports for RACH attempts towards an MCG or towards an SCG or both.

The UE may filter and send to the network the RA reports based on the third indication received from the network.

The UE may delete a part of the RA reports already sent to the network, while keeping the rest of the RA reports not reported to the network.

Some embodiments provide a method at a network node. The network node may receive a second indication that indicates the availability of logged RA information including the first indication indicating whether the RA procedure is performed towards a cell belonging to the MCG or belonging to the SCG.

The network node may send a third indication that indicates a request to UE to send all or some of the RA reports, in the RA report list.

The network node may receive an RA report including the first indication of whether the RA was performed toward a MCG or SCG.

In some embodiments, the network receiving the RA Report including the above characteristics can analyze them and deduce whether RA performance needs to be adjusted for RACH towards MCGs, or SCGs, or towards any specific RAT (e.g. LTE or NR). Alternatively, the network may deduce that the performance denoted by the RA reports is due to sub-optimal mobility policies towards MCGs or SCGs or towards specific RATs (for example in case of too early mobility towards such cells) or instead whether the performance is due to lack of coverage by those access networks.

Certain embodiments may provide one or more of the following technical advantage(s). Having an indication in the RACH report indicating whether the RA procedure is performed toward a cell belonging to the Master Cell Group (MCG) or toward a cell belonging to the Secondary Cell Group (SCG) enables a better analysis of the RA report by the RAN nodes. For example, RA procedure performed toward the SN due to the SN addition may be triggered, more aggressively e.g., by events with lower radio link quality thresholds, while for e.g., for a HO procedure the triggering condition might be set in such a way that RA procedure being triggered at good coverage of the target cell.

Hence knowing this information (i.e., whether the RA is performed toward the MCG or toward the SCG) at the network side, enables the RAN node to configure the mobility and/or SCG addition associated events optimally. In addition, it enables the RAN node to adjust the coverage of the SCG associated cells, not mixing the coverage issue with the aggressive policies of other RAN nodes (MN here) in establishing DC.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram that shows an LTE cell with a single beam and an NR cell with multiple beams.

FIG. 2 illustrates an example of SSB and RACH occasion configurations when the number of SSBs per RACH occasions is one.

FIG. 3 illustrates an example of SSB and RACH occasion configurations when the each SSBs maps to multiple RACH occasions.

FIG. 4 illustrates selection of different SSBs by a UE.

FIGS. 5A and 5B are sequence diagrams of the UE and network node according to some embodiments.

FIG. 6 is a block diagram illustrating a wireless device UE according to some embodiments of inventive concepts.

FIG. 7 is a block diagram illustrating a radio access network RAN node (e.g., a base station eNB/gNB) according to some embodiments of inventive concepts.

FIG. 8 is a block diagram illustrating a core network CN node (e.g., an AMF node, an SMF node, etc.) according to some embodiments of inventive concepts.

FIG. 9 is a flow chart illustrating operations of a UE according to some embodiments of inventive concepts.

FIGS. 10 and 11 are flow charts illustrating operations of RAN nodes according to some embodiments of inventive concepts.

FIG. 12 is a block diagram of a communication system in accordance with some embodiments.

FIG. 13 is a block diagram of a user equipment in accordance with some embodiments.

FIG. 14 is a block diagram of a network node in accordance with some embodiments.

FIG. 15 is a block diagram of a host computer communicating with a user equipment in accordance with some embodiments.

FIG. 16 is a block diagram of a virtualization environment in accordance with some embodiments.

FIG. 17 is a block diagram of a host computer communicating via a base station with a user equipment over a partially wireless connection in accordance with some embodiments in accordance with some embodiments.

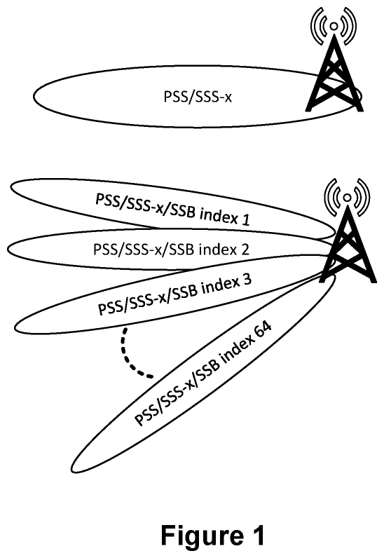

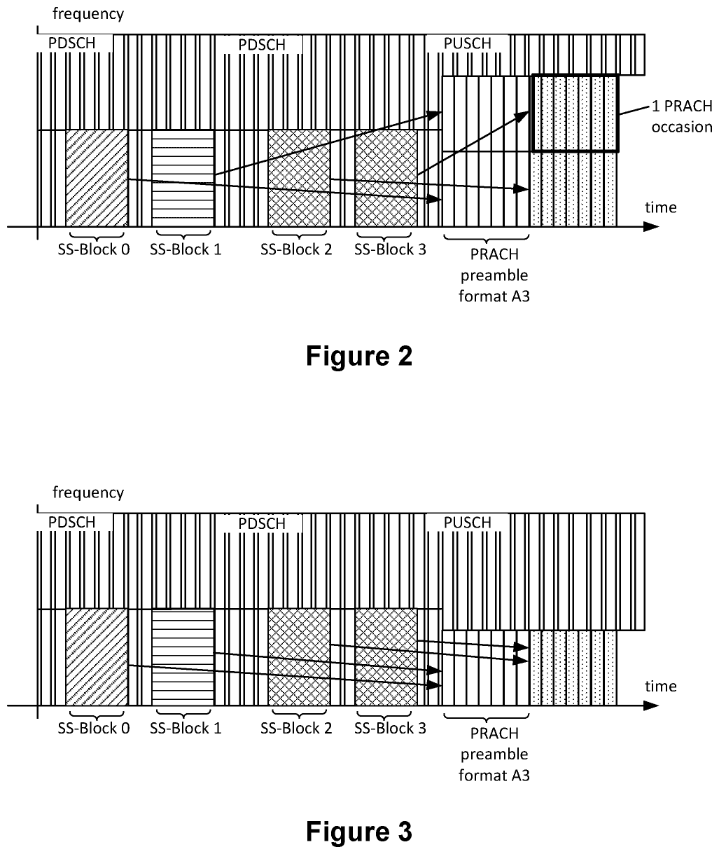

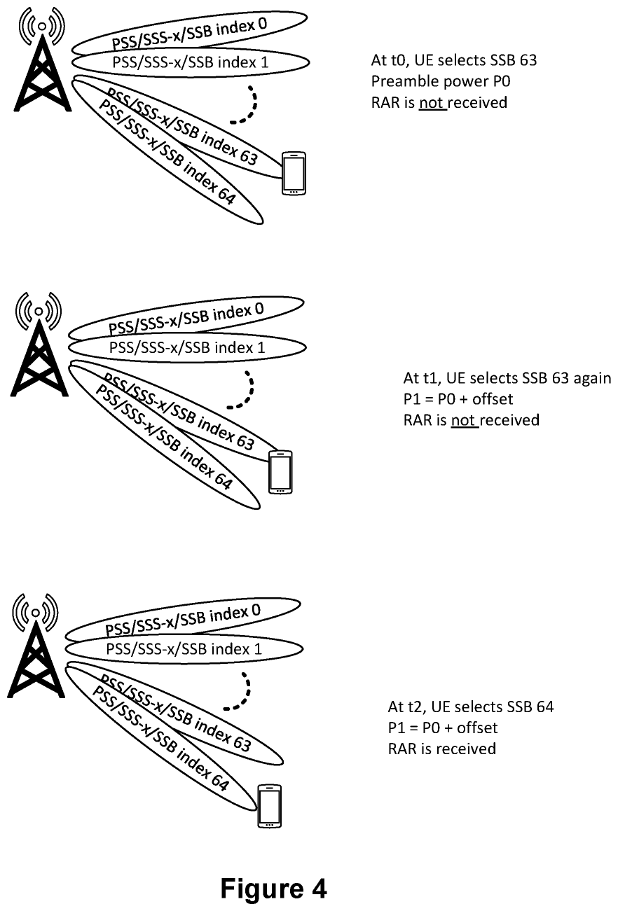

### DETAILED DESCRIPTION

Some of the embodiments contemplated herein will now be described more fully with reference to the accompanying drawings. Embodiments are provided by way of example to convey the scope of the subject matter to those skilled in the art., in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

Embodiments described herein are applicable to both LTE and NR RAN nodes. In the present description, the terms “network node” and “RAN node” are used interchangeably. A non-limiting example of a network node or a RAN node can be an eNB, gNB, gNB-CU, gNB-CU-CP, or gNB-DU.

There currently exist certain challenge(s). The 3GPP RAN2 has agreed at meeting #115-e that the UE reports the secondary node (SN) related RA-report to the master node (MN). The agreement provides that the UE reports the SN RACH report to the MN, and then the MN sends the SN RACH report to the MN.

The current RA procedure specified in Ref. [4] logs a RA report upon successful execution of the RA procedure. Given the above agreement, the same RA-report is logged for the RA procedures performed on a cell belonging to the Secondary Cell Group. However, a RAN node receiving and analyzing the report would not be able to recognize whether the RA procedure was executed toward a cell belonging to the SCG or MCG. Hence the RAN node would not be able to determine whether the RACH performance reported via the RA report by the UE is due to a mobility policy to access the MN or the SN. With that, the network is not able to determine which mobility policy needs to be adjusted or indeed whether the issue that may be determined by analysis of the RA report is due to coverage issues instead of mobility policy adjustment. For example, if MN uses an aggressive policy for SCG addition (e.g., if it tries to add an SCG when the radio signals for that cell are still low), the RA procedure may need multiple attempts to succeed. If the RA report is signalled from the MN to the SN without any additional information, the SN will not be able to understand that the RACH access was due to SCG addition. The SN may deduce that the RACH is for other reasons and with that conclude that its cells suffer of poor coverage, while it was the (too aggressive) SN addition policy by the MN that caused such a bad performance for the performed RA procedure.

That is, the network is not aware when it receives RA report that it was to a SCG.

Another problem is that the specifications so far allow for only one RA report for LTE. This does not allow the network to build a complete understanding of RACH accesses occurred in the past and their performance.

Accordingly, under current specifications, a network (NW) is not aware when it receives RA report that it was to a SCG. Some embodiments enable a UE to indicate that an RA report was sent to an MCG or SCG. This information gives better insight to the RAN node, and in particular the RAN nodes in which played a role of a SN and received RA reports, which may allow the RAN nodes to better adjust their radio coverage.

For a performed RA procedure, the UE logs a first indication that indicates whether a performed RA procedure is performed toward a cell belonging to the Master Cell Group (MCG) serving the UE, or toward a cell belonging the secondary Cell Group (SCG) serving the UE. The RA related information including the first indication will be logged in a list of RA reports, in such a way that each RA report includes an instance of the first indication.

This indication will allow the RAN node receiving the RA Report (e.g. the MN or SN) to understand that the RACH process was performed due to an MCG addition or due to an SCG addition. As an example, an SN may trigger RACH procedures because the UE has lost synchronization towards the SCG. Such RACH procedure will result in the reporting of a RA report by the UE. Similarly, the UE may perform RACH towards the same SN cell but in this case due to an SCG addition or SCG change (i.e. change of PSCell). The latter RACH access will also generate a RA Report by the UE. These two RACH accesses are therefore due to different reasons and triggered by different policies. If the network is able to understand for which process such RACH accesses were triggered, the network may also be able to derive the policy according to which the RACH access was triggered and determine if the RACH performance recorded in the RA report is due, for example, to a bad policy configuration or bad cell coverage.

The UE may transmit to the network a second indication that indicates the logged RA related information, including the first indication indicating whether the RA procedure is performed toward a cell belonging to the MCG or belonging to the SCG.

In one embodiment the second indication indicates information concerning the release of the RA report. For example, the second indication may indicate that the RA report is from Release 16 or Release 17 according to the 3GPP specification.

This approach provides the advantage of constructing Rel17 reports that maybe richer than they would otherwise be. For example, they may include both LTE and NR RACH reports. Such rich reports would allow the network to gain a broader view of all the RACH accesses the UE performed and also to maintain a chronological order between RACH accesses for different RATs, e.g. LTE and NR. This approach also implies that the receiving RAN should be able to decode all types of RA reports listed in the enhanced Rel17 version. It should be noted that the RA reports in some embodiments do not necessarily need to be labeled as “Rel16” and “Rel17”. The embodiment can be generalized to the classification of RA Reports that are legacy or that are enhanced, where an enhancement can be denoted by means of a release indication or by means of characteristics such as multi-RAT RA reporting.

In another embodiment, the second indication indicates the radio access technology of the RA report, for example, whether the RA was performed toward an LTE network or an NR network.

This approach implies that the UE can form one RA report list per RAT. The advantage of this approach is that, depending on the RAT where the UE accesses, the corresponding RA Report list can be retrieved by the network. Hence, the network would not understand RA reports for a non-served RAT, the network may not retrieve such RA Report list. The UE would therefore keep the non-retrieved RA Report List and store it until a network that can decode it and use it retrieves it.

In some embodiments, the UE may receive a third indication from the network node that indicates a request for the UE to send all or some of the RA reports in the RA report list.

In one embodiment the third indication received from the network node indicates information concerning the release of the RA report, such as a RA report from release 16 or release 17 according to the 3GPP specification.

In another embodiment, the third indication received from the network node indicates the radio access technology of the RA report. E.g., the RA belonging to the LTE network or to the NR network.

The UE may filter and send to the network the RA reports based on the third indication received from the network.

In some embodiments, the UE may delete a part of the RA reports already sent to the network, while keeping the rest of the RA reports not reported to the network.

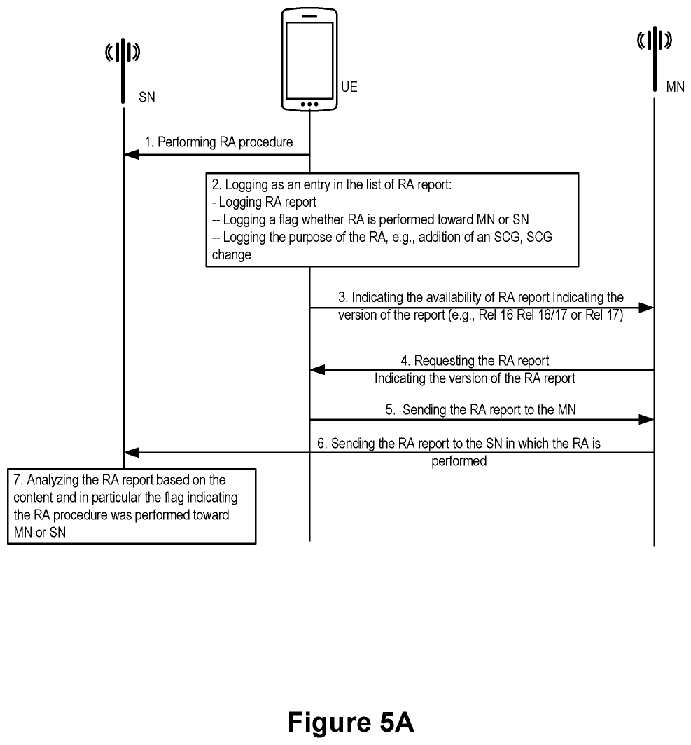

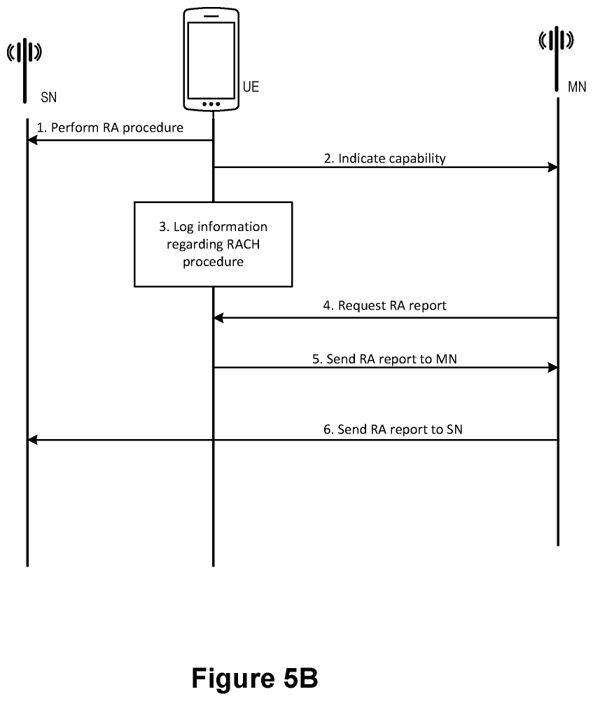

FIG. 5A is a sequence diagram of the UE and network node actions upon performing an RA procedure toward a cell belonging to Secondary Cell Group (SCG) according to some embodiments.

Referring to FIG. 5A, at step 1, the UE performs an RA procedure toward a cell belonging to an SCG.

At step 2, the UE logs the RA related information as part of an item in the list of the RA reports. For example, the UE may log whether RA procedure is performed toward a cell belonging to the MCG or to the SCG. In some embodiments, the UE may log the purpose of the RA procedure such as SCG addition, SCG change, etc. In some further embodiments, the UE may log an LTE RA report in the same variable (a list of RA reports) in which an NR RA report is logged.

In further embodiments, the UE may log whether the RA procedure toward a cell was successful or failed. In further embodiments, UE may log whether the RA procedure toward a cell belonging to the SCG was successful or failed

At step 3, the UE indicates the availability of the RA report to the network e.g., to the MN. In some embodiments, the version or the release of the RA report, e.g. release 16, or release 16 and/or release 17, or release 17, etc., is indicated.

At step 4, the MN sends a request to the UE fetch the RA report. In some embodiments, the request may specify the version or the release of the RA report that is requested, e.g. release 16, or release 16 and/or release 17, or release 17, etc.

At step 5, the UE sends the RA reports based on the received request to the MN. The UE may delete the part sent to the network from its list of RA reports variable.

At step 6, the MN sends the RA report to the SN in which the RA procedure associated to the RA report was performed toward it.

At step 7, the SN analyzes the report and adjusts the coverage taking into account the flag indicating whether the RA procedure is performed as part of an SCG addition procedure or SCG change procedure or due to whether the RA report was towards a specific RAT.

Although FIG. 5A illustrates an example where the UE performs an RA procedure toward a cell in an SCG served by a SN, it will be appreciated that in the case where the UE performs an RA procedure toward a cell in an MCG or toward a cell in an SCG served by a MN, the UE will provide the RA report associated with the RA procedure directly to the MN.

In further embodiments, the UE may indicate the SCG RA report capability to the RAN. That is, the UE may report its support for generating and providing an RA report associated with a secondary RAT that could be either EUTRA or NR. A capable UE that supports such reporting may log the RA report in a chronological order between RACH accesses. For example, a UE operating in an in MR-DC configuration may log an MCG RA report and an SCG RA report in NR RAT. Note that UE logs the SCG RA Report for the EUTRA RAT separately. With this approach, a receiving RAN that is upgraded with standard Rel-17 RA report support gains a full view of all the RACH accesses the UE performed in both MCG/SCG MR-DC configuration and single connectivity. In case that the receiving RAN is not upgraded with Rel-17 RA report support, the receiving RAN may request the older version of the report e.g., a Rel-16 RA report (legacy version). Referring to FIG. 5B, a UE, SN and MN may perform the following operations according to some embodiments.
Step 1. The UE performs an RA procedure toward a cell belonging to an SCG.
Step 2. The UE indicates its capability to the network (the availability of the RA report version to the network e.g., Rel-16, Rel-17, etc, to the MN).
Step 3. The UE logs the RA related information as part of an item in a list of the RA reports.

The UE may log whether RA procedure is performed toward a cell belonging to the MCG or to the SCG. In some embodiments, the UE may log the purpose of the RA procedure, such as SCG addition, SCG change, etc. In yet further embodiments, the UE may log an LTE RA report in the same variable (e.g., a list of RA reports) in which an NR RA report is logged. In further embodiments, the UE may log whether the RA procedure toward a cell was successful or failed. In further embodiments, the UE may log whether the RA procedure toward a cell belonging to the SCG was successful or failed.
Step 4. The MN sends a request to the UE fetch the RA report. The request may be based on the UE capability provided in Step 2. In some embodiments, the request may identify the version or the release of the RA report being requested (e.g., Rel-16, Rel-17, etc.).
Step 5. In response to the request, the UE sends the RA report to the MN. The UE may delete the RA report sent to the network from its list of RA reports variable. In some embodiments, the response indicates the version or the requested release of the RA report.
Step 6. The MN sends the RA report to the SN toward which the RA procedure associated with the RA report was performed. The SN may analyze the report and adjust its coverage taking into account information in the RA report indicating whether the RA procedure was performed as part of an SCG addition procedure or SCG change procedure or based on information in the RA report identifying whether the RA report was based on a RA procedure towards a specific RAT.

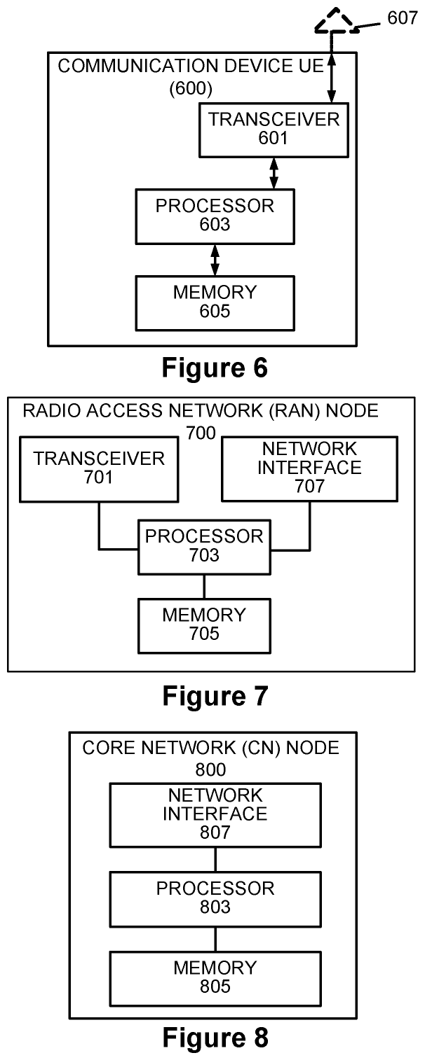

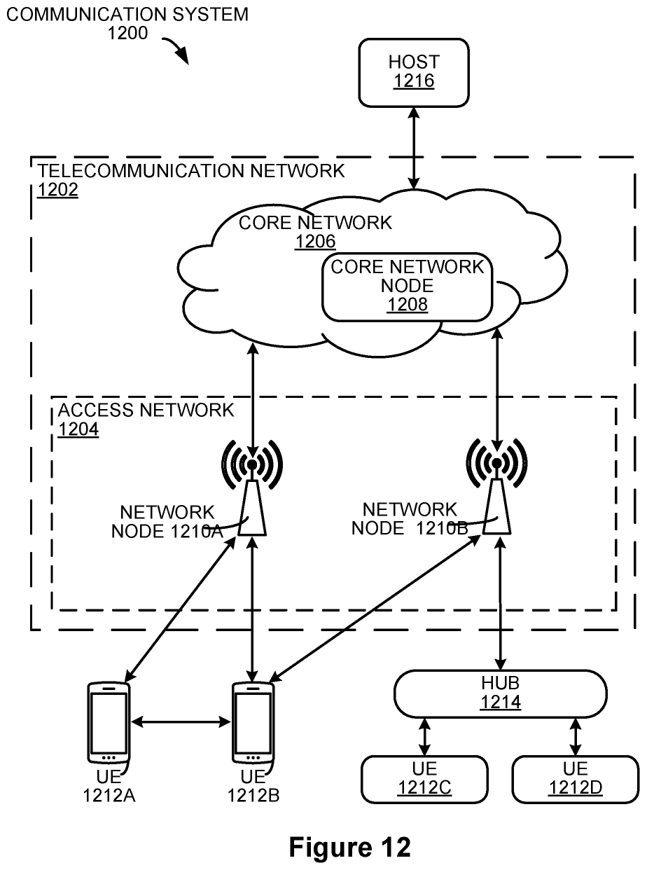

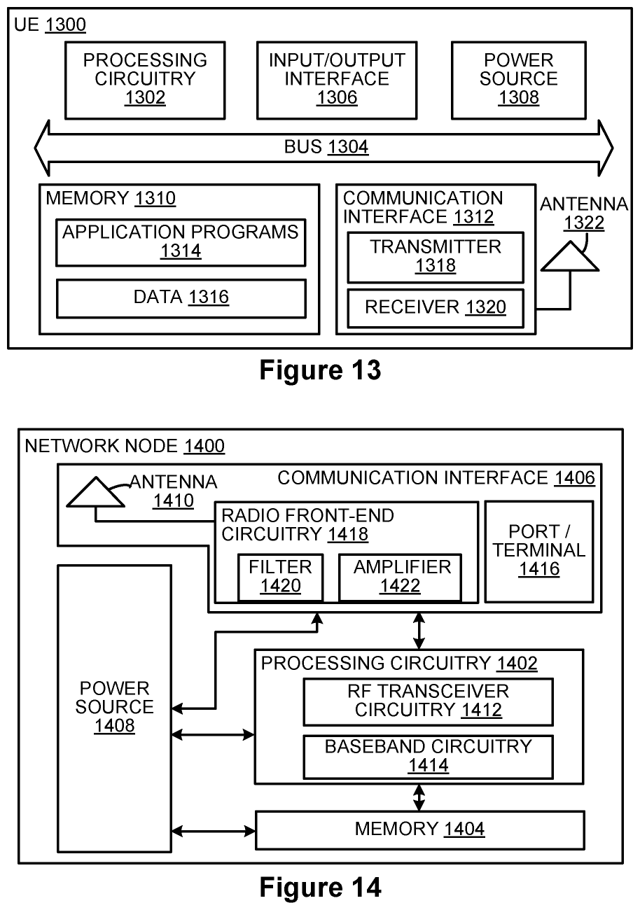

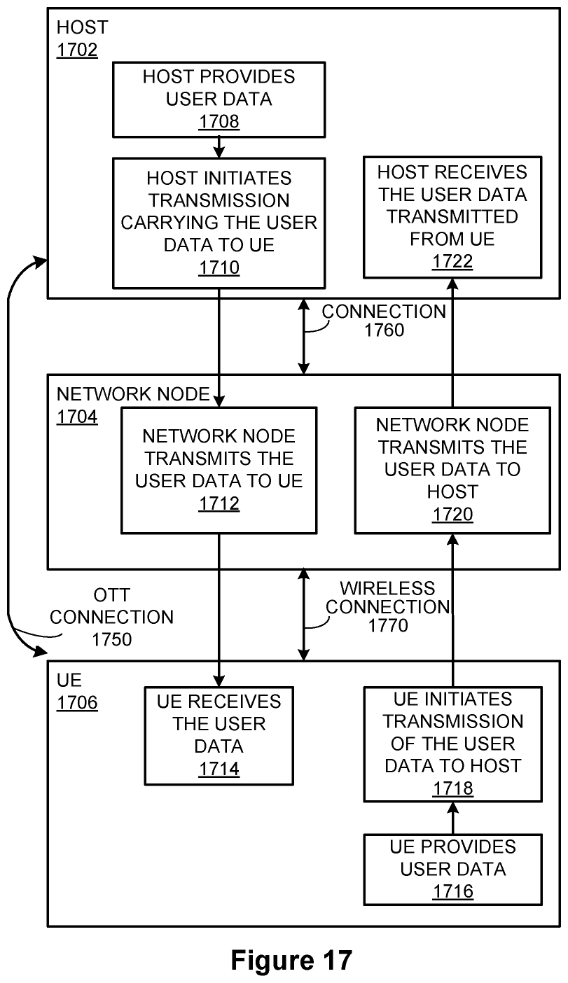

FIG. 6 is a block diagram illustrating elements of a communication device UE 600 (also referred to as a mobile terminal, a mobile communication terminal, a wireless device, a wireless communication device, a wireless terminal, mobile device, a wireless communication terminal, user equipment, UE, a user equipment node/terminal/device, etc.) configured to provide wireless communication according to embodiments of inventive concepts. (Communication device 600 may be provided, for example, as discussed below with respect to wireless devices UE 1212A, UE 1212B, and wired or wireless devices UE 1212C, UE 1212D of FIG. 12, UE 1300 of FIG. 13, virtualization hardware 1604 and virtual machines 1608A, 1608B of FIG. 16, and UE 1706 of FIG. 17, all of which should be considered interchangeable in the examples and embodiments described herein and be within the intended scope of this disclosure, unless otherwise noted.) As shown, communication device UE may include an antenna 307 (e.g., corresponding to antenna 1322 of FIG. 13), and transceiver circuitry 301 (also referred to as a transceiver, e.g., corresponding to interface 1312 of FIG. 13 having transmitter 1318 and receiver 1320) including a transmitter and a receiver configured to provide uplink and downlink radio communications with a base station(s) (e.g., corresponding to network node 1210A, 1210B of FIG. 12, network node 1400 of FIG. 14, and network node 1704 of FIG. 17 also referred to as a RAN node) of a radio access network. Communication device UE may also include processing circuitry 603 (also referred to as a processor, e.g., corresponding to processing circuitry 1302 of FIG. 13, and control system 1612 of FIG. 16) coupled to the transceiver circuitry, and memory circuitry 605 (also referred to as memory, e.g., corresponding to memory 1310 of FIG. 12) coupled to the processing circuitry. The memory circuitry 605 may include computer readable program code that when executed by the processing circuitry 603 causes the processing circuitry to perform operations according to embodiments disclosed herein. According to other embodiments, processing circuitry 603 may be defined to include memory so that separate memory circuitry is not required. Communication device UE may also include an interface (such as a user interface) coupled with processing circuitry 603, and/or communication device UE may be incorporated in a vehicle.

As discussed herein, operations of communication device UE may be performed by processing circuitry 603 and/or transceiver circuitry 601. For example, processing circuitry 603 may control transceiver circuitry 601 to transmit communications through transceiver circuitry 601 over a radio interface to a radio access network node (also referred to as a base station) and/or to receive communications through transceiver circuitry 601 from a RAN node over a radio interface. Moreover, modules may be stored in memory circuitry 605, and these modules may provide instructions so that when instructions of a module are executed by processing circuitry 603, processing circuitry 603 performs respective operations (e.g., operations discussed below with respect to Example Embodiments relating to wireless communication devices). According to some embodiments, a communication device UE 600 and/or an element(s)/function(s) thereof may be embodied as a virtual node/nodes and/or a virtual machine/machines.

FIG. 7 is a block diagram illustrating elements of a radio access network RAN node 700 (also referred to as a network node, base station, eNodeB/eNB, gNodeB/gNB, etc.) of a Radio Access Network (RAN) configured to provide cellular communication according to embodiments of inventive concepts. (RAN node 700 may be provided, for example, as discussed below with respect to network node 1210A, 1210B of FIG. 12, network node 1400 of FIG. 14, hardware 1604 or virtual machine 1608A, 1608B of FIG. 16, and/or base station 1704 of FIG. 17, all of which should be considered interchangeable in the examples and embodiments described herein and be within the intended scope of this disclosure, unless otherwise noted.) As shown, the RAN node may include transceiver circuitry 701 (also referred to as a transceiver, e.g., corresponding to portions of RF transceiver circuitry 1412 and radio front end circuitry 1418 of FIG. 14) including a transmitter and a receiver configured to provide uplink and downlink radio communications with mobile terminals. The RAN node may include network interface circuitry 707 (also referred to as a network interface, e.g., corresponding to portions of communication interface 1406 of FIG. 14) configured to provide communications with other nodes (e.g., with other base stations) of the RAN and/or core network CN. The network node may also include processing circuitry 703 (also referred to as a processor, e.g., corresponding to processing circuitry 1402 of FIG. 14) coupled to the transceiver circuitry, and memory circuitry 705 (also referred to as memory, e.g., corresponding to memory 1404 of FIG. 14) coupled to the processing circuitry. The memory circuitry 705 may include computer readable program code that when executed by the processing circuitry 703 causes the processing circuitry to perform operations according to embodiments disclosed herein. According to other embodiments, processing circuitry 703 may be defined to include memory so that a separate memory circuitry is not required.

As discussed herein, operations of the RAN node may be performed by processing circuitry 703, network interface 707, and/or transceiver 701. For example, processing circuitry 703 may control transceiver 701 to transmit downlink communications through transceiver 701 over a radio interface to one or more mobile terminals UEs and/or to receive uplink communications through transceiver 701 from one or more mobile terminals UEs over a radio interface. Similarly, processing circuitry 703 may control network interface 707 to transmit communications through network interface 707 to one or more other network nodes and/or to receive communications through network interface from one or more other network nodes. Moreover, modules may be stored in memory 705, and these modules may provide instructions so that when instructions of a module are executed by processing circuitry 703, processing circuitry 703 performs respective operations (e.g., operations discussed below with respect to Example Embodiments relating to RAN nodes). According to some embodiments, RAN node 700 and/or an element(s)/function(s) thereof may be embodied as a virtual node/nodes and/or a virtual machine/machines.

According to some other embodiments, a network node may be implemented as a core network CN node without a transceiver. In such embodiments, transmission to a wireless communication device UE may be initiated by the network node so that transmission to the wireless communication device UE is provided through a network node including a transceiver (e.g., through a base station or RAN node). According to embodiments where the network node is a RAN node including a transceiver, initiating transmission may include transmitting through the transceiver.

FIG. 8 is a block diagram illustrating elements of a core network (CN) node (e.g., an SMF (session management function) node, an AMF (access and mobility management function) node, etc.) of a communication network configured to provide cellular communication according to embodiments of inventive concepts. (CN node 800 may be provided, for example, as discussed below with respect to core network node 1208 of FIG. 12, hardware 1604 or virtual machine 1608A, 1608B of FIG. 16, all of which should be considered interchangeable in the examples and embodiments described herein and be within the intended scope of this disclosure, unless otherwise noted) As shown, the CN node may include network interface circuitry 807 configured to provide communications with other nodes of the core network and/or the radio access network RAN. The CN node may also include a processing circuitry 803 (also referred to as a processor,) coupled to the network interface circuitry, and memory circuitry 805 (also referred to as memory) coupled to the processing circuitry. The memory circuitry 805 may include computer readable program code that when executed by the processing circuitry 803 causes the processing circuitry to perform operations according to embodiments disclosed herein. According to other embodiments, processing circuitry 803 may be defined to include memory so that a separate memory circuitry is not required.

As discussed herein, operations of the CN node may be performed by processing circuitry 803 and/or network interface circuitry 807. For example, processing circuitry 803 may control network interface circuitry 807 to transmit communications through network interface circuitry 807 to one or more other network nodes and/or to receive communications through network interface circuitry from one or more other network nodes. Moreover, modules may be stored in memory 505, and these modules may provide instructions so that when instructions of a module are executed by processing circuitry 503, processing circuitry 503 performs respective operations (e.g., operations discussed below with respect to Example Embodiments relating to core network nodes). According to some embodiments, CN node 500 and/or an element(s)/function(s) thereof may be embodied as a virtual node/nodes and/or a virtual machine/machines.

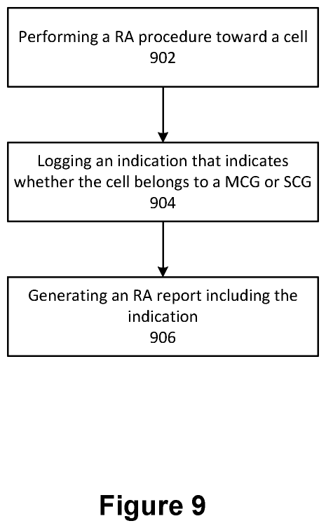

In the description that follows, while the communication device may be any of the communication device 600, wireless device 1212A, 1212B, wired or wireless devices UE 1212C, UE 1212D, UE 1300, virtualization hardware 1604, virtual machines 1608A, 1608B, or UE 1706, the communication device 300 shall be used to describe the functionality of the operations of the communication device. Operations of the communication device 300 (implemented using the structure of the block diagram of FIG. 6) will now be discussed with reference to the flow chart of FIG. 9 according to some embodiments of inventive concepts. For example, modules may be stored in memory 305 of FIG. 6, and these modules may provide instructions so that when the instructions of a module are executed by respective communication device processing circuitry 303, processing circuitry 303 performs respective operations of the flow chart.

Referring to FIG. 9, a method performed by a UE includes performing (block 902) a random access, RA, procedure towards a cell of a radio access network, logging (block 904) a first indication that indicates whether the cell towards which the RA procedure was performed belongs to a master cell group, MCG, or a secondary cell group, SCG, serving the UE, and generating (block 906) an RA report that includes the first indication of whether the RA procedure was performed toward a cell belonging to an MCG or an SCG.

The method may further include transmitting a message to the radio access network indicating availability of the RA report.

In some embodiments, the method may further include logging a second indication that includes information concerning a standard release of the RA report, wherein the message includes the second indication.

In some embodiments, the method may further include logging a third indication that indicates a radio access technology associated with the RA report, wherein the message includes the third indication.

In some embodiments, the method may further include logging a fifth indication that indicates whether or not the RA procedure was successful, wherein the RA report includes the fifth indication.

The method may further include receiving a request from a master node, MN, serving the UE to transmit the RA report to the MN. The request may indicate a standard release of the requested RA report and/or may indicate information concerning a radio access technology associated with the requested RA report. The request may indicate whether the requested report is associated with an RA procedure towards an MCG or an SCG.

In some embodiments, the method may further include transmitting the RA report to the MN in response to the request.

In some embodiments, the method may further include filtering the RA report in response to information in the request.

In some embodiments, the method may further include deleting the RA report after sending the RA report to the MN.

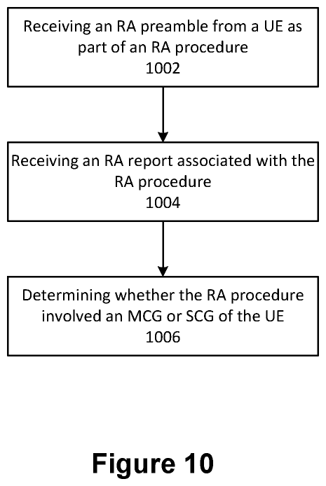

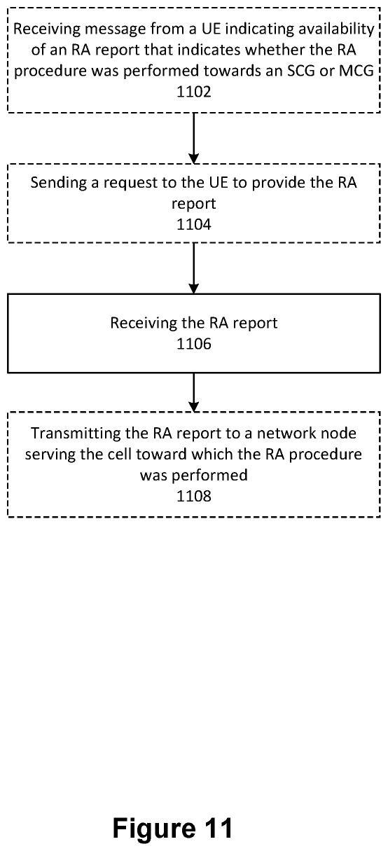

In the description that follows, while the network node may be any of the RAN node 700, network node 1210A, 1210B, 1400, 1706, hardware 1604, or virtual machine 1608A, 1608B, the RAN node 700 shall be used to describe the functionality of the operations of the network node. Operations of the RAN node 700 (implemented using the structure of FIG. 7) will now be discussed with reference to the flow charts of FIGS. 10 and 11 according to some embodiments of inventive concepts. For example, modules may be stored in memory 705 of FIG. 7, and these modules may provide instructions so that when the instructions of a module are executed by respective RAN node processing circuitry 703, processing circuitry 703 performs respective operations of the flow chart.

FIG. 10 illustrates a method performed by a RAN node. Referring to FIG. 10, the method includes receiving (block 1002) a random access, RA, preamble from a user equipment, UE, as part of a RA procedure towards a cell served by the RAN node, receiving (block 1004) a RA report associated with the RA procedure, the RA report indicating whether the cell towards which the RA procedure was performed belongs to a master cell group, MCG, or a secondary cell group, SCG, serving the UE, and determining (block 1006) whether the RA procedure was toward a cell belonging to an MCG or SCG serving the UE based on the RA report.

The RA report may indicate a standard release of the RA report and/or a radio access technology associated with the RA report.

The method may further include adjusting a RA procedure parameter in response to the RA report.

Receiving the RA report may include receiving the RA report from a master node serving the UE. In some embodiments, the RA report may be received from the UE.

FIG. 11 illustrates a method performed by a RAN node, such as a master node (MN), according to some embodiments. Referring to FIG. 11, the method includes receiving (block 1106) a random access, RA, report associated with a RA procedure performed by a user equipment, UE, the RA report indicating whether the cell towards which the RA procedure was performed belongs to a master cell group, MCG, or a secondary cell group, SCG, serving the UE.

The method may optionally include transmitting (block 1108) the RA report to a network node serving the cell toward which the RA procedure was performed.

The method may optionally include receiving (block 1102) a message from the UE indicating availability of the RA report, and transmitting (block 1104) a request to the UE requesting the RA report from the UE.

The RA message may indicate a standard release of the RA report and/or a radio access technology associated with the RA report and/or whether or not the RA procedure was successful.

In some embodiments, the RA report is received from the UE.

FIG. 12 shows an example of a communication system 1200 in accordance with some embodiments.

In the example, the communication system 1200 includes a telecommunication network 1202 that includes an access network 1204, such as a radio access network (RAN), and a core network 1206, which includes one or more core network nodes 1208. The access network 1204 includes one or more access network nodes, such as network nodes 1210a and 1210b (one or more of which may be generally referred to as network nodes 1210), or any other similar 3rd Generation Partnership Project (3GPP) access node or non-3GPP access point. The network nodes 1210 facilitate direct or indirect connection of user equipment (UE), such as by connecting UEs 1212a, 1212b, 1212c, and 1212d (one or more of which may be generally referred to as UEs 1212) to the core network 1206 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1200 may include any number of wired or wireless networks, network nodes, UEs, and/or any other components or systems that may facilitate or participate in the communication of data and/or signals whether via wired or wireless connections. The communication system 1200 may include and/or interface with any type of communication, telecommunication, data, cellular, radio network, and/or other similar type of system.

The UEs 1212 may be any of a wide variety of communication devices, including wireless devices arranged, configured, and/or operable to communicate wirelessly with the network nodes 1210 and other communication devices. Similarly, the network nodes 1210 are arranged, capable, configured, and/or operable to communicate directly or indirectly with the UEs 1212 and/or with other network nodes or equipment in the telecommunication network 1202 to enable and/or provide network access, such as wireless network access, and/or to perform other functions, such as administration in the telecommunication network 1202.

In the depicted example, the core network 1206 connects the network nodes 1210 to one or more hosts, such as host 1216. These connections may be direct or indirect via one or more intermediary networks or devices. In other examples, network nodes may be directly coupled to hosts. The core network 1206 includes one more core network nodes (e.g., core network node 1208) that are structured with hardware and software components. Features of these components may be substantially similar to those described with respect to the UEs, network nodes, and/or hosts, such that the descriptions thereof are generally applicable to the corresponding components of the core network node 1208. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1216 may be under the ownership or control of a service provider other than an operator or provider of the access network 1204 and/or the telecommunication network 1202, and may be operated by the service provider or on behalf of the service provider. The host 1216 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1200 of FIG. 12 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1202 is a cellular network that implements 3GPP standardized features. Accordingly, the telecommunications network 1202 may support network slicing to provide different logical networks to different devices that are connected to the telecommunication network 1202. For example, the telecommunications network 1202 may provide Ultra Reliable Low Latency Communication (URLLC) services to some UEs, while providing Enhanced Mobile Broadband (eMBB) services to other UEs, and/or Massive Machine Type Communication (mMTC)/Massive IT services to yet further UEs.

In some examples, the UEs 1212 are configured to transmit and/or receive information without direct human interaction. For instance, a UE may be designed to transmit information to the access network 1204 on a predetermined schedule, when triggered by an internal or external event, or in response to requests from the access network 1204. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1214 communicates with the access network 1204 to facilitate indirect communication between one or more UEs (e.g., UE 1212c and/or 1212d) and network nodes (e.g., network node 1210b). In some examples, the hub 1214 may be a controller, router, content source and analytics, or any of the other communication devices described herein regarding UEs. For example, the hub 1214 may be a broadband router enabling access to the core network 1206 for the UEs. As another example, the hub 1214 may be a controller that sends commands or instructions to one or more actuators in the UEs. Commands or instructions may be received from the UEs, network nodes 1210, or by executable code, script, process, or other instructions in the hub 1214. As another example, the hub 1214 may be a data collector that acts as temporary storage for UE data and, in some embodiments, may perform analysis or other processing of the data. As another example, the hub 1214 may be a content source. For example, for a UE that is a VR headset, display, loudspeaker or other media delivery device, the hub 1214 may retrieve VR assets, video, audio, or other media or data related to sensory information via a network node, which the hub 1214 then provides to the UE either directly, after performing local processing, and/or after adding additional local content. In still another example, the hub 1214 acts as a proxy server or orchestrator for the UEs, in particular in if one or more of the UEs are low energy IoT devices.

The hub 1214 may have a constant/persistent or intermittent connection to the network node 1210b. The hub 1214 may also allow for a different communication scheme and/or schedule between the hub 1214 and UEs (e.g., UE 1212c and/or 1212d), and between the hub 1214 and the core network 1206. In other examples, the hub 1214 is connected to the core network 1206 and/or one or more UEs via a wired connection. Moreover, the hub 1214 may be configured to connect to an M2M service provider over the access network 1204 and/or to another UE over a direct connection. In some scenarios, UEs may establish a wireless connection with the network nodes 1210 while still connected via the hub 1214 via a wired or wireless connection. In some embodiments, the hub 1214 may be a dedicated hub—that is, a hub whose primary function is to route communications to/from the UEs from/to the network node 1210b. In other embodiments, the hub 1214 may be a non-dedicated hub—that is, a device which is capable of operating to route communications between the UEs and network node 1210b, but which is additionally capable of operating as a communication start and/or end point for certain data channels.

FIG. 13 shows a UE 1300 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1300 includes processing circuitry 1302 that is operatively coupled via a bus 1304 to an input/output interface 1306, a power source 1308, a memory 1310, a communication interface 1312, and/or any other component, or any combination thereof. Certain UEs may utilize all or a subset of the components shown in FIG. 13. The level of integration between the components may vary from one UE to another UE. Further, certain UEs may contain multiple instances of a component, such as multiple processors, memories, transceivers, transmitters, receivers, etc.

The processing circuitry 1302 is configured to process instructions and data and may be configured to implement any sequential state machine operative to execute instructions stored as machine-readable computer programs in the memory 1310. The processing circuitry 1302 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1302 may include multiple central processing units (CPUs).

In the example, the input/output interface 1306 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1300. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1308 is structured as a battery or battery pack. Other types of power sources, such as an external power source (e.g., an electricity outlet), photovoltaic device, or power cell, may be used. The power source 1308 may further include power circuitry for delivering power from the power source 1308 itself, and/or an external power source, to the various parts of the UE 1300 via input circuitry or an interface such as an electrical power cable. Delivering power may be, for example, for charging of the power source 1308. Power circuitry may perform any formatting, converting, or other modification to the power from the power source 1308 to make the power suitable for the respective components of the UE 1300 to which power is supplied.

The memory 1310 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1310 includes one or more application programs 1314, such as an operating system, web browser application, a widget, gadget engine, or other application, and corresponding data 1316. The memory 1310 may store, for use by the UE 1300, any of a variety of various operating systems or combinations of operating systems.

The memory 1310 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1310 may allow the UE 1300 to access instructions, application programs and the like, stored on transitory or non-transitory memory media, to off-load data, or to upload data. An article of manufacture, such as one utilizing a communication system may be tangibly embodied as or in the memory 1310, which may be or comprise a device-readable storage medium.

The processing circuitry 1302 may be configured to communicate with an access network or other network using the communication interface 1312. The communication interface 1312 may comprise one or more communication subsystems and may include or be communicatively coupled to an antenna 1322. The communication interface 1312 may include one or more transceivers used to communicate, such as by communicating with one or more remote transceivers of another device capable of wireless communication (e.g., another UE or a network node in an access network). Each transceiver may include a transmitter 1318 and/or a receiver 1320 appropriate to provide network communications (e.g., optical, electrical, frequency allocations, and so forth). Moreover, the transmitter 1318 and receiver 1320 may be coupled to one or more antennas (e.g., antenna 1322) and may share circuit components, software or firmware, or alternatively be implemented separately.

In the illustrated embodiment, communication functions of the communication interface 1312 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1312, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1300 shown in FIG. 13.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 14 shows a network node 1400 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1400 includes a processing circuitry 1402, a memory 1404, a communication interface 1406, and a power source 1408. The network node 1400 may be composed of multiple physically separate components (e.g., a NodeB component and a RNC component, or a BTS component and a BSC component, etc.), which may each have their own respective components. In certain scenarios in which the network node 1400 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1400 may be configured to support multiple radio access technologies (RATs). In such embodiments, some components may be duplicated (e.g., separate memory 1404 for different RATs) and some components may be reused (e.g., a same antenna 1410 may be shared by different RATs). The network node 1400 may also include multiple sets of the various illustrated components for different wireless technologies integrated into network node 1400, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1400.

The processing circuitry 1402 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1400 components, such as the memory 1404, to provide network node 1400 functionality.

In some embodiments, the processing circuitry 1402 includes a system on a chip (SOC). In some embodiments, the processing circuitry 1402 includes one or more of radio frequency (RF) transceiver circuitry 1412 and baseband processing circuitry 1414. In some embodiments, the radio frequency (RF) transceiver circuitry 1412 and the baseband processing circuitry 1414 may be on separate chips (or sets of chips), boards, or units, such as radio units and digital units. In alternative embodiments, part or all of RF transceiver circuitry 1412 and baseband processing circuitry 1414 may be on the same chip or set of chips, boards, or units.

The memory 1404 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1402. The memory 1404 may store any suitable instructions, data, or information, including a computer program, software, an application including one or more of logic, rules, code, tables, and/or other instructions capable of being executed by the processing circuitry 1402 and utilized by the network node 1400. The memory 1404 may be used to store any calculations made by the processing circuitry 1402 and/or any data received via the communication interface 1406. In some embodiments, the processing circuitry 1402 and memory 1404 is integrated.

The communication interface 1406 is used in wired or wireless communication of signaling and/or data between a network node, access network, and/or UE. As illustrated, the communication interface 1406 comprises port(s)/terminal(s) 1416 to send and receive data, for example to and from a network over a wired connection. The communication interface 1406 also includes radio front-end circuitry 1418 that may be coupled to, or in certain embodiments a part of, the antenna 1410. Radio front-end circuitry 1418 comprises filters 1420 and amplifiers 1422. The radio front-end circuitry 1418 may be connected to an antenna 1410 and processing circuitry 1402. The radio front-end circuitry may be configured to condition signals communicated between antenna 1410 and processing circuitry 1402. The radio front-end circuitry 1418 may receive digital data that is to be sent out to other network nodes or UEs via a wireless connection. The radio front-end circuitry 1418 may convert the digital data into a radio signal having the appropriate channel and bandwidth parameters using a combination of filters 1420 and/or amplifiers 1422. The radio signal may then be transmitted via the antenna 1410. Similarly, when receiving data, the antenna 1410 may collect radio signals which are then converted into digital data by the radio front-end circuitry 1418. The digital data may be passed to the processing circuitry 1402. In other embodiments, the communication interface may comprise different components and/or different combinations of components.

In certain alternative embodiments, the network node 1400 does not include separate radio front-end circuitry 1418, instead, the processing circuitry 1402 includes radio front-end circuitry and is connected to the antenna 1410. Similarly, in some embodiments, all or some of the RF transceiver circuitry 1412 is part of the communication interface 1406. In still other embodiments, the communication interface 1406 includes one or more ports or terminals 1416, the radio front-end circuitry 1418, and the RF transceiver circuitry 1412, as part of a radio unit (not shown), and the communication interface 1406 communicates with the baseband processing circuitry 1414, which is part of a digital unit (not shown).

The antenna 1410 may include one or more antennas, or antenna arrays, configured to send and/or receive wireless signals. The antenna 1410 may be coupled to the radio front-end circuitry 1418 and may be any type of antenna capable of transmitting and receiving data and/or signals wirelessly. In certain embodiments, the antenna 1410 is separate from the network node 1400 and connectable to the network node 1400 through an interface or port.

The antenna 1410, communication interface 1406, and/or the processing circuitry 1402 may be configured to perform any receiving operations and/or certain obtaining operations described herein as being performed by the network node. Any information, data and/or signals may be received from a UE, another network node and/or any other network equipment. Similarly, the antenna 1410, the communication interface 1406, and/or the processing circuitry 1402 may be configured to perform any transmitting operations described herein as being performed by the network node. Any information, data and/or signals may be transmitted to a UE, another network node and/or any other network equipment.

The power source 1408 provides power to the various components of network node 1400 in a form suitable for the respective components (e.g., at a voltage and current level needed for each respective component). The power source 1408 may further comprise, or be coupled to, power management circuitry to supply the components of the network node 1400 with power for performing the functionality described herein. For example, the network node 1400 may be connectable to an external power source (e.g., the power grid, an electricity outlet) via an input circuitry or interface such as an electrical cable, whereby the external power source supplies power to power circuitry of the power source 1408. As a further example, the power source 1408 may comprise a source of power in the form of a battery or battery pack which is connected to, or integrated in, power circuitry. The battery may provide backup power should the external power source fail.

Embodiments of the network node 1400 may include additional components beyond those shown in FIG. 14 for providing certain aspects of the network node's functionality, including any of the functionality described herein and/or any functionality necessary to support the subject matter described herein. For example, the network node 1400 may include user interface equipment to allow input of information into the network node 1400 and to allow output of information from the network node 1400. This may allow a user to perform diagnostic, maintenance, repair, and other administrative functions for the network node 1400.

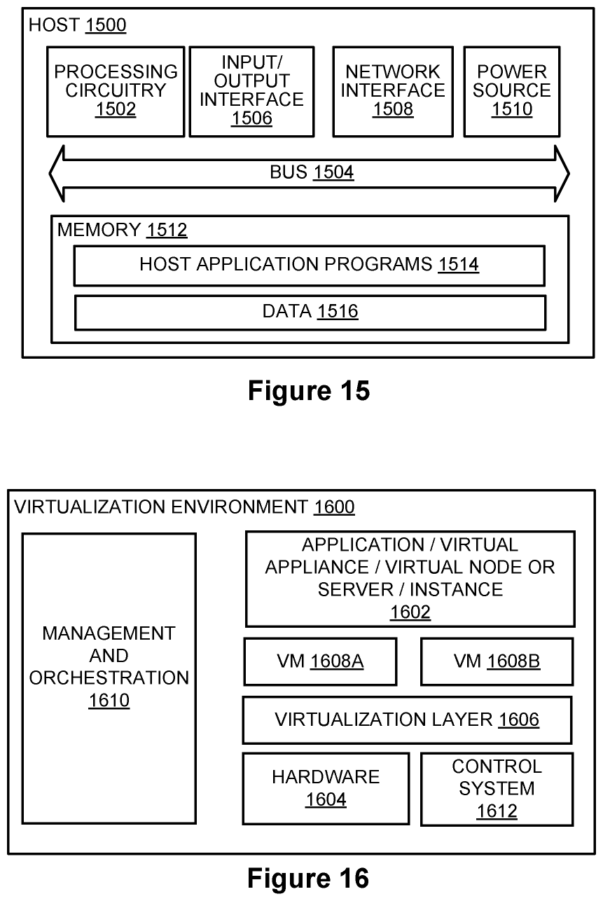

FIG. 15 is a block diagram of a host 1500, which may be an embodiment of the host 1216 of FIG. 12, in accordance with various aspects described herein. As used herein, the host 1500 may be or comprise various combinations hardware and/or software, including a standalone server, a blade server, a cloud-implemented server, a distributed server, a virtual machine, container, or processing resources in a server farm. The host 1500 may provide one or more services to one or more UEs.

The host 1500 includes processing circuitry 1502 that is operatively coupled via a bus 1504 to an input/output interface 1506, a network interface 1508, a power source 1510, and a memory 1512. Other components may be included in other embodiments. Features of these components may be substantially similar to those described with respect to the devices of previous figures, such as FIGS. 13 and 14, such that the descriptions thereof are generally applicable to the corresponding components of host 1500.

The memory 1512 may include one or more computer programs including one or more host application programs 1514 and data 1516, which may include user data, e.g., data generated by a UE for the host 1500 or data generated by the host 1500 for a UE. Embodiments of the host 1500 may utilize only a subset or all of the components shown. The host application programs 1514 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1514 may also provide for user authentication and licensing checks and may periodically report health, routes, and content availability to a central node, such as a device in or on the edge of a core network. Accordingly, the host 1500 may select and/or indicate a different host for over-the-top services for a UE. The host application programs 1514 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 16 is a block diagram illustrating a virtualization environment 1600 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1600 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1602 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1604 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1606 (also referred to as hypervisors or virtual machine monitors (VMMs)), provide VMs 1608a and 1608b (one or more of which may be generally referred to as VMs 1608), and/or perform any of the functions, features and/or benefits described in relation with some embodiments described herein. The virtualization layer 1606 may present a virtual operating platform that appears like networking hardware to the VMs 1608.

The VMs 1608 comprise virtual processing, virtual memory, virtual networking or interface and virtual storage, and may be run by a corresponding virtualization layer 1606. Different embodiments of the instance of a virtual appliance 1602 may be implemented on one or more of VMs 1608, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1608 may be a software implementation of a physical machine that runs programs as if they were executing on a physical, non-virtualized machine. Each of the VMs 1608, and that part of hardware 1604 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1608 on top of the hardware 1604 and corresponds to the application 1602.

Hardware 1604 may be implemented in a standalone network node with generic or specific components. Hardware 1604 may implement some functions via virtualization. Alternatively, hardware 1604 may be part of a larger cluster of hardware (e.g. such as in a data center or CPE) where many hardware nodes work together and are managed via management and orchestration 1610, which, among others, oversees lifecycle management of applications 1602. In some embodiments, hardware 1604 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1612 which may alternatively be used for communication between hardware nodes and radio units.

FIG. 17 shows a communication diagram of a host 1702 communicating via a network node 1704 with a UE 1706 over a partially wireless connection in accordance with some embodiments. Example implementations, in accordance with various embodiments, of the UE (such as a UE 1212a of FIG. 12 and/or UE 1300 of FIG. 13), network node (such as network node 1210a of FIG. 12 and/or network node 1400 of FIG. 14), and host (such as host 1216 of FIG. 12 and/or host 1500 of FIG. 15) discussed in the preceding paragraphs will now be described with reference to FIG. 17.

Like host 1500, embodiments of host 1702 include hardware, such as a communication interface, processing circuitry, and memory. The host 1702 also includes software, which is stored in or accessible by the host 1702 and executable by the processing circuitry. The software includes a host application that may be operable to provide a service to a remote user, such as the UE 1706 connecting via an over-the-top (OTT) connection 1750 extending between the UE 1706 and host 1702. In providing the service to the remote user, a host application may provide user data which is transmitted using the OTT connection 1750.

The network node 1704 includes hardware enabling it to communicate with the host 1702 and UE 1706. The connection 1760 may be direct or pass through a core network (like core network 1206 of FIG. 12) and/or one or more other intermediate networks, such as one or more public, private, or hosted networks. For example, an intermediate network may be a backbone network or the Internet.

The UE 1706 includes hardware and software, which is stored in or accessible by UE 1706 and executable by the UE's processing circuitry. The software includes a client application, such as a web browser or operator-specific “app” that may be operable to provide a service to a human or non-human user via UE 1706 with the support of the host 1702. In the host 1702, an executing host application may communicate with the executing client application via the OTT connection 1750 terminating at the UE 1706 and host 1702. In providing the service to the user, the UE's client application may receive request data from the host's host application and provide user data in response to the request data. The OTT connection 1750 may transfer both the request data and the user data. The UE's client application may interact with the user to generate the user data that it provides to the host application through the OTT connection 1750.

The OTT connection 1750 may extend via a connection 1760 between the host 1702 and the network node 1704 and via a wireless connection 1770 between the network node 1704 and the UE 1706 to provide the connection between the host 1702 and the UE 1706. The connection 1760 and wireless connection 1770, over which the OTT connection 1750 may be provided, have been drawn abstractly to illustrate the communication between the host 1702 and the UE 1706 via the network node 1704, without explicit reference to any intermediary devices and the precise routing of messages via these devices.

As an example of transmitting data via the OTT connection 1750, in step 1708, the host 1702 provides user data, which may be performed by executing a host application. In some embodiments, the user data is associated with a particular human user interacting with the UE 1706. In other embodiments, the user data is associated with a UE 1706 that shares data with the host 1702 without explicit human interaction. In step 1710, the host 1702 initiates a transmission carrying the user data towards the UE 1706. The host 1702 may initiate the transmission responsive to a request transmitted by the UE 1706. The request may be caused by human interaction with the UE 1706 or by operation of the client application executing on the UE 1706. The transmission may pass via the network node 1704, in accordance with the teachings of the embodiments described throughout this disclosure. Accordingly, in step 1712, the network node 1704 transmits to the UE 1706 the user data that was carried in the transmission that the host 1702 initiated, in accordance with the teachings of the embodiments described throughout this disclosure. In step 1714, the UE 1706 receives the user data carried in the transmission, which may be performed by a client application executed on the UE 1706 associated with the host application executed by the host 1702.

In some examples, the UE 1706 executes a client application which provides user data to the host 1702. The user data may be provided in reaction or response to the data received from the host 1702. Accordingly, in step 1716, the UE 1706 may provide user data, which may be performed by executing the client application. In providing the user data, the client application may further consider user input received from the user via an input/output interface of the UE 1706. Regardless of the specific manner in which the user data was provided, the UE 1706 initiates, in step 1718, transmission of the user data towards the host 1702 via the network node 1704. In step 1720, in accordance with the teachings of the embodiments described throughout this disclosure, the network node 1704 receives user data from the UE 1706 and initiates transmission of the received user data towards the host 1702. In step 1722, the host 1702 receives the user data carried in the transmission initiated by the UE 1706.

One or more of the various embodiments improve the performance of OTT services provided to the UE 1706 using the OTT connection 1750, in which the wireless connection 1770 forms the last segment. More precisely, the teachings of these embodiments may improve the performance of random access procedures and thereby provide benefits such as to allow the network to more efficiently configure the mobility and/or SCG addition associated events.

In an example scenario, factory status information may be collected and analyzed by the host 1702. As another example, the host 1702 may process audio and video data which may have been retrieved from a UE for use in creating maps. As another example, the host 1702 may collect and analyze real-time data to assist in controlling vehicle congestion (e.g., controlling traffic lights). As another example, the host 1702 may store surveillance video uploaded by a UE. As another example, the host 1702 may store or control access to media content such as video, audio, VR or AR which it can broadcast, multicast or unicast to UEs. As other examples, the host 1702 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1750 between the host 1702 and UE 1706, in response to variations in the measurement results. The measurement procedure and/or the network functionality for reconfiguring the OTT connection may be implemented in software and hardware of the host 1702 and/or UE 1706. In some embodiments, sensors (not shown) may be deployed in or in association with other devices through which the OTT connection 1750 passes; the sensors may participate in the measurement procedure by supplying values of the monitored quantities exemplified above, or supplying values of other physical quantities from which software may compute or estimate the monitored quantities. The reconfiguring of the OTT connection 1750 may include message format, retransmission settings, preferred routing etc.; the reconfiguring need not directly alter the operation of the network node 1704. Such procedures and functionalities may be known and practiced in the art. In certain embodiments, measurements may involve proprietary UE signaling that facilitates measurements of throughput, propagation times, latency and the like, by the host 1702. The measurements may be implemented in that software causes messages to be transmitted, in particular empty or ‘dummy’ messages, using the OTT connection 1750 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

Explanations are provided below for various abbreviations/acronyms used in the present disclosure.

### Abbreviation Explanation

3GPP 3rd Generation Partnership Project
5G 5th Generation
CHO Conditional handover
BWP Bandwidth Part
CSI-RS Channel State Information Reference Signal
CU Central Unit
DC Dual Connectivity
DL Downlink
DU Distributed Unit
eNB Evolved Node B
E-UTRAN Evolved Universal Terrestrial Radio Access Network
gNB Radio base station in 5G/NR.
gNB-CU gNodeB Central Unit
gNB-CU-CP gNodeB Central Unit Control Plane
gNB-DU gNodeB Distributed Unit
GNSS Global Navigation Satellite System
GPS Global Positioning System
HO Handover
HOF Handover Failure
LTE Long Term Evolution
MAC Medium Access Control
MCG Master Cell group
MIB Master Information Block
MN Master Node
NR New Radio
NW Network
O&M Operation and Maintenance
PCell Primary Cell
PCI Physical Cell Identifier
PRACH Physical Random Access Channel
RACH Random Access Channel
RAN Radio Access Network
RA Random Access
RA report Random Access report
RAR Random Access Response
RAT Radio Access Technology
RLF Radio Link Failure
RRC Radio Resource Control
SCG Secondary Cell Group
SIB System information Block
SN Secondary Node
SIB1 System Information block 1
SIB2 System Information block 2
SRB Signalling Radio Bearer
SRB1 Signaling Radio Bearer 1
SRB2 Signalling Radio Bearer 2
SSB Synchronization Signal Block
UE User Equipment
UL Uplink
UTC Coordinated Universal Time

### References are Identified Below

[1] 3GPP TS 36.321 V16.3.0 (2020-12) Technical Specification 3rd Generation Partnership Project; Technical Specification Group Radio Access Network; Evolved Universal Terrestrial Radio Access (E-UTRA); Medium Access Control (MAC) protocol specification (Release 16).
[2] 3GPP TS 36.331 V16.0.0 (2020-03) Technical Specification 3rd Generation Partnership Project; Technical Specification Group Radio Access Network; Evolved Universal Terrestrial Radio Access (E-UTRA); Radio Resource Control (RRC); Protocol specification (Release 16).
[3] 3GPP TS 38.321 V16.1.0 (2020-07) Technical Specification 3rd Generation Partnership Project; Technical Specification Group Radio Access Network; NR; Medium Access Control (MAC) protocol specification (Release 16).
[4] 3GPP TS 38.331 V16.5.0 (2021-06) Technical Specification 3rd Generation Partnership Project; Technical Specification Group Radio Access Network; NR; Radio Resource Control (RRC) protocol specification (Release 16).

1. A method performed by a user equipment (UE), comprising:
performing a random access (RA) procedure towards a cell of a radio access network;
logging a first indication that indicates whether the cell towards which the RA procedure was performed belongs to a master cell group, (MCG) or a secondary cell group, (SCG) serving the UE; and
generating an RA report that includes the first indication of whether the RA procedure was performed toward a cell belonging to the MCG or the SCG.

2. The method of claim 1, further comprising transmitting a message to the radio access network indicating availability of the RA report.

3. The method of claim 1, further comprising:
logging a second indication that includes information concerning a standard release of the RA report, wherein the message includes the second indication.

4. The method of claim 1, further comprising:
logging a third indication that indicates a radio access technology associated with the RA report, wherein the message includes the third indication.

5. The method of claim 1, further comprising:
logging a fourth indication that indicates whether or not the RA procedure was successful, wherein the RA report includes the fourth indication.

6. The method of claim 1, further comprising:
receiving a request from a master node (MN) serving the UE to transmit the RA report to the MN.

7. The method of claim 5, wherein the request indicates a standard release of the requested RA report.

8. The method of claim 5, wherein the request indicates information concerning a radio access technology associated with the requested RA report.

9. The method of claim 5, wherein the request indicates whether the requested report is associated with an RA procedure towards the MCG or the SCG.

10. The method of claim 5, further comprising:
transmitting the RA report to the MN in response to the request.

11. The method of claim 5, further comprising:
filtering the RA report in response to information in the request.

12. The method of claim 9, further comprising:
deleting the RA report after sending the RA report to the MN.

13. A user equipment, comprising:
processing circuitry configured to:
perform a random access (RA) procedure towards a cell of a radio access network;
log a first indication that indicates whether the cell towards which the RA procedure was performed belongs to a master cell group (MCG) or a secondary cell group (SCG) serving the UE; and
generate an RA report that includes the first indication of whether the RA procedure was performed toward a cell belonging to the MCG or the SCG; and
power supply circuitry configured to supply power to the processing circuitry.

14. (canceled)

15. A method performed by a radio access network, RAN, (RAN) node, comprising:
receiving a random access (RA) preamble from a user equipment (UE) as part of an RA procedure towards a cell served by the RAN node;
receiving an RA report associated with the RA procedure, the RA report indicating whether the cell towards which the RA procedure was performed belongs to a master cell group, (MCG) or a secondary cell group, (SCG) serving the UE; and
determining whether the RA procedure was toward a cell belonging to the MCG or the SCG serving the UE based on the RA report.

16. The method of claim 15, wherein the RA report indicates a standard release of the RA report.

17. The method of claim 15, wherein the RA report indicates a radio access technology associated with the RA report.

18. The method of claim 15, further comprising:
adjusting an RA procedure parameter in response to the RA report.

19. The method of claim 15, wherein receiving the RA report comprises receiving the RA report from a master node serving the UE.

20. The method of claim 15, wherein receiving the RA report comprises receiving the RA report from the UE.

21-29. (canceled)
